(19) United States
(12) Patent Application Publication
(10) Pub. No.: US 2026/0349804 A1
(43) Pub. Date: Nov. 5, 2026

(54) CROSS-CLOUD COMPARISON AND AUTOMATED MIGRATION SYSTEM AND METHOD

(71) Applicant: BEREEJ TECHNOLOGIES PRIVATE LIMITED, PUNE (IN)

(72) Inventors: Sudeep Mohan KHIRE, Pune (IN); Shubham KHATAL, Pune (IN); Sagar Balasaheb KHATAL, Pune (IN); Ashutosh YADAV, Pune (IN)

(21) Appl. No.: 19/194,258

(22) Filed: Apr. 30, 2025

(51) Int. Cl. G06F 9/50; G06F 9/455; G06Q 10/0631

(52) U.S. Cl. CPC G06F 9/5027; G06F 9/45558; G06Q 10/06312; G06F 2009/45595

(57) ABSTRACT

A method includes determining, by the at least one processor, a cloud computing environment in a first cloud computing platform by performing image processing on a cloud computing diagram, determining, by the at least one processor, a cost for the cloud computing environment in the first cloud computing platform and an equivalent cloud computing environment available for at least one second cloud computing platform, displaying, by the at least one processor, the cost for the cloud computing environment in the first cloud computing platform and the equivalent cloud computing environment available for the at least one second cloud computing platform, receiving, by the at least one processor, a selection of the at least one second cloud computing platform and converting the cloud computing environment in the first cloud computing platform to the equivalent cloud computing environment for the at least one second cloud computing platform.

### BACKGROUND

Managing cloud costs and optimizing resources across multiple cloud computing platforms is a challenge. Each cloud computing platform provides different options and it is difficult to compare the options from one provider to the options from another provider.

It is with these issues in mind, among others, that various aspects of the disclosure were conceived.

### SUMMARY

According to one aspect, a cross-cloud comparison and automated migration system may include one or more client computing devices that may have a cross-cloud comparison and automated migration application and one or more server computing devices that may have the cross-cloud comparison and automated migration application. A user may use the client computing device to connect to a cloud computing platform account. The user may draw a cloud landscape diagram that represents a cloud computing architecture. Based on the cloud landscape diagram, the cross-cloud comparison and automated migration application may obtain a current monthly cost and compare resource costs of a representation of the cloud computing architecture between multiple different cloud computing platforms. The cross-cloud comparison and automated migration application may display a configuration for each cloud computing platform that is based on the cloud landscape diagram and indicate cost information for each cloud computing platform.

The cross-cloud comparison and automated migration application may determine an equivalent network infrastructure for each cloud computing platform and determine a cost estimation for each cloud computing platform based on the equivalent network infrastructure. The system may present information associated with a cost analysis between the cloud computing platforms. In addition, the cross-cloud comparison and automated migration application may convert one network infrastructure associated with a cloud computing platform to a different cloud computing platform by maintaining architecture, networking, and dependencies during the conversion. In addition, the cross-cloud comparison and automated migration application may perform automated provisioning of target cloud resources in a second cloud computing platform based on a source configuration in the first cloud computing platform. As a result, the system provides infrastructure migration including data transfer as well as secure and compliant data movement between cloud providers. The system may use automated scripts to replicate data storage structures in one cloud computing platform to a second cloud computing platform.

According to an aspect, a method includes receiving, by at least one processor, a cloud computing diagram that represents a cloud computing environment, determining, by the at least one processor, a cloud computing environment in a first cloud computing platform by performing image processing on the cloud computing diagram, determining, by the at least one processor, a cost for the cloud computing environment in the first cloud computing platform and an equivalent cloud computing environment available for at least one second cloud computing platform, displaying, by the at least one processor, the cost for the cloud computing environment in the first cloud computing platform and the equivalent cloud computing environment available for the at least one second cloud computing platform, receiving, by the at least one processor, a selection of the at least one second cloud computing platform and converting the cloud computing environment in the first cloud computing platform to the equivalent cloud computing environment for the at least one second cloud computing platform, and provisioning, by the at least one processor, cloud resources for the equivalent cloud computing platform for the at least one second cloud computing platform.

According to another aspect, a system includes a computing device comprising a memory storing computer-readable instructions and at least one processor to execute the instructions to receive a cloud computing diagram that represents a cloud computing environment, determine a cloud computing environment in a first cloud computing platform by performing image processing on the cloud computing diagram, determine a cost for the cloud computing environment in the first cloud computing platform and an equivalent cloud computing environment available for at least one second cloud computing platform, display the cost for the cloud computing environment in the first cloud computing platform and the equivalent cloud computing environment available for the at least one second cloud computing platform, receive a selection of the at least one second cloud computing platform and convert the cloud computing environment in the first cloud computing platform to the equivalent cloud computing environment for the at least one second cloud computing platform, and provision cloud resources for the equivalent cloud computing platform for the at least one second cloud computing platform.

According to an additional aspect, a non-transitory computer-readable storage medium includes instructions stored thereon that, when executed by a computing device cause the computing device to perform operations, the operations including receiving a cloud computing diagram that represents a cloud computing environment, determining a cloud computing environment in a first cloud computing platform by performing image processing on the cloud computing diagram, determining a cost for the cloud computing environment in the first cloud computing platform and an equivalent cloud computing environment available for at least one second cloud computing platform, displaying the cost for the cloud computing environment in the first cloud computing platform and the equivalent cloud computing environment available for the at least one second cloud computing platform, receiving a selection of the at least one second cloud computing platform and converting the cloud computing environment in the first cloud computing platform to the equivalent cloud computing environment for the at least one second cloud computing platform, and provisioning cloud resources for the equivalent cloud computing platform for the at least one second cloud computing platform.

These and other aspects, features, and benefits of the present disclosure will become apparent from the following detailed written description of the preferred embodiments and aspects taken in conjunction with the following drawings, although variations and modifications thereto may be effected without departing from the spirit and scope of the novel concepts of the disclosure.

### BRIEF DESCRIPTION OF THE DRAWINGS

The accompanying drawings illustrate embodiments and/or aspects of the disclosure and, together with the written description, serve to explain the principles of the disclosure. Wherever possible, the same reference numbers are used throughout the drawings to refer to the same or like elements of an embodiment, and wherein:

FIG. 1 is a diagram of a cross-cloud comparison and automated migration system according to an example of the instant disclosure.

FIG. 2A is an example method of performing cross-cloud comparison and automated migration according to an example of the instant disclosure.

FIG. 2B is a continuation of the example method shown in FIG. 2A according to an example of the instant disclosure.

FIG. 3 is a screenshot of a graphical user interface of a cross-cloud comparison and automated migration application according to an example of the instant disclosure.

FIG. 4 is another screenshot of the graphical user interface of the cross-cloud comparison and automated migration application according to an example of the instant disclosure.

FIG. 5 is another screenshot of the graphical user interface of the cross-cloud comparison and automated migration application according to an example of the instant disclosure.

FIG. 6 is another screenshot of the graphical user interface of the cross-cloud comparison and automated migration application according to an example of the instant disclosure.

FIG. 7 is another screenshot of the graphical user interface of the cross-cloud comparison and automated migration application according to an example of the instant disclosure.

FIG. 8 shows a flowchart of a method of performing cross-cloud comparison and automated migration according to an example of the instant disclosure.

FIG. 9 shows an example of a system for implementing certain aspects of the present technology according to an example of the instant disclosure.

### DETAILED DESCRIPTION

The present invention is more fully described below with reference to the accompanying figures. The following description is exemplary in that several embodiments are described (e.g., by use of the terms “preferably,” “for example,” or “in one embodiment”); however, such should not be viewed as limiting or as setting forth the only embodiments of the present invention, as the invention encompasses other embodiments not specifically recited in this description, including alternatives, modifications, and equivalents within the spirit and scope of the invention. Further, the use of the terms “invention,” “present invention,” “embodiment,” and similar terms throughout the description are used broadly and not intended to mean that the invention requires, or is limited to, any particular aspect being described or that such description is the only manner in which the invention may be made or used. Additionally, the invention may be described in the context of specific applications; however, the invention may be used in a variety of applications not specifically described.

The embodiment(s) described, and references in the specification to “one embodiment”, “an embodiment”, “an example embodiment”, etc., indicate that the embodiment(s) described may include a particular feature, structure, or characteristic. Such phrases are not necessarily referring to the same embodiment. When a particular feature, structure, or characteristic is described in connection with an embodiment, persons skilled in the art may effect such feature, structure, or characteristic in connection with other embodiments whether or not explicitly described.

In the several figures, like reference numerals may be used for like elements having like functions even in different drawings. The embodiments described, and their detailed construction and elements, are merely provided to assist in a comprehensive understanding of the invention. Thus, it is apparent that the present invention can be carried out in a variety of ways, and does not require any of the specific features described herein. Also, well-known functions or constructions are not described in detail since they would obscure the invention with unnecessary detail. Any signal arrows in the drawings/figures should be considered only as exemplary, and not limiting, unless otherwise specifically noted. Further, the description is not to be taken in a limiting sense, but is made merely for the purpose of illustrating the general principles of the invention, since the scope of the invention is best defined by the appended claims.

It will be understood that, although the terms “first,” “second,” etc. may be used herein to describe various elements, these elements should not be limited by these terms. These terms are only used to distinguish one element from another. Purely as a non-limiting example, a first element could be termed a second element, and, similarly, a second element could be termed a first element, without departing from the scope of example embodiments. As used herein, the term “and/or” includes any and all combinations of one or more of the associated listed items. As used herein, the singular forms “a”, “an,” and “the” are intended to include the plural forms as well, unless the context clearly indicates otherwise. It should also be noted that, in some alternative implementations, the functions and/or acts noted may occur out of the order as represented in at least one of the several figures. Purely as a non-limiting example, two figures shown in succession may in fact be executed substantially concurrently or may sometimes be executed in the reverse order, depending upon the functionality and/or acts described or depicted.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

A system and method provides cross-cloud cost comparison and automated infrastructure migration and a novel approach to cost optimization and seamless cross-cloud infrastructure migration. This allows users to compare cloud resource costs across multiple cloud providers (Amazon Web Services (AWS), IBM Cloud, Microsoft Azure, Google Cloud Platform (GCP), DigitalOcean, and others) and display equivalent resource configurations. In one example, there may be cloud resources that may be underutilized. While determining the equivalent resource configurations, the system may propose that reduced cloud resources be used. The system further enables automated migration of infrastructure structure between cloud providers while maintaining the same architecture but without transferring data. The system also enables full infrastructure migration, including data transfer.

Managing cloud costs and optimizing resources across multiple cloud platforms is a critical challenge. The system provides a cross-cloud cost comparison tool that provides insights into equivalent infrastructure pricing across AWS, IBM Cloud, Azure, GCP, and DigitalOcean, among others. Additionally, this functionality supports the automated conversion of resource configurations from one cloud provider to another, simplifying cloud migration efforts and cost-saving decisions.

### Cross-Cloud Cost Comparison

In one example, a user provides authentication information associated with a cloud account (e.g., AWS or a first cloud computing platform). Next, the user may draw a cloud landscape diagram representing their infrastructure. The system may obtain information associated with a current monthly cost (e.g., $1,000) based on the cloud landscape diagram. The system may compare resource costs of the infrastructure between one or more cloud computing platforms such as AWS, Azure, IBM Cloud, GCP, and DigitalOcean, among others. The system may display equivalent configurations across different cloud providers and may show potential savings percentage by switching providers. The system provides support for virtual machine (VM) instances, storage, databases, networking components, and other cloud services.

### Infrastructure Mapping & Cost Simulation

The system may determine the equivalent network infrastructure in other cloud providers. Example: AWS EC2 t2.micro is equivalent to Azure VM Standard_B1ms. The system may perform a cost simulation across all cloud providers based on equivalent configurations and present a comparative cost analysis to the user.

Infrastructure Conversion Across Cloud Providers

The system may convert one cloud infrastructure into an equivalent cloud infrastructure such as one of AWS, Azure, IBM Cloud, GCP, Oracle Cloud Infrastructure (OCI), or DigitalOcean infrastructure. The system may maintain architecture, networking, and dependencies during conversion and provide automated provisioning of target cloud resources based on source configuration.

### Seamless Migration

The system may enable full infrastructure migration, including data transfer and provide secure and compliant data movement between cloud providers. Additionally, the system provides automated scripts to replicate data storage structures in the target cloud.

### Implementation Details

The system may include a cost comparison engine. The cost comparison engine may utilize APIs from AWS, Azure, IBM Cloud, GCP, OCI, and DigitalOcean or others to fetch real-time pricing. The cost comparison engine may implement cost analysis logic to identify cost differences and savings and present cost comparisons in a user-friendly user interface.

The system may include an infrastructure mapping algorithm (IMA).

The IMA may analyze existing infrastructure components in a cloud computing platform and map them to equivalent services in another cloud computing platform. Additionally, the IMA may maintain network topology, compute configurations, and security settings. The IMA may use Terraform-based templates for automated infrastructure deployment.

### Migration Workflow (Without Data Transfer)

The system may include migration workflow without data transfer to identify and extract the source cloud architecture. The migration workflow may map source cloud components to equivalent target cloud components. The migration workflow may display a preview of the proposed infrastructure in the target cloud and deploy the equivalent infrastructure in the target cloud provider.

### Full Migration with Data Transfer

The system may include full migration with data transfer. In other words, if there are applications installed, the applications may be migrated. An image is obtained of a first cloud computing environment including applications and data and a second cloud computing environment is created that may be equivalent that includes the applications and data. In one example, the full migration with data transfer may implement automated data migration pipelines, support database replication across cloud providers, and ensure minimal downtime during migration.

### Use Case Examples

Example 1: AWS API Gateway with Lambda and RDS Migration to Azure

Source (AWS): API Gateway→Lambda→AWS RDS

Target (Azure Equivalent): Azure API Management→Azure Functions→Azure SQL Database

The system may identify cost differences and deploy equivalent Azure services.

Example 2: AWS Load Balancer with EC2 Instances and RDS Migration to Azure

Source (AWS): Load Balancer→3 EC2 Instances→RDS

Target (Azure Equivalent): Azure Load Balancer→3 Virtual Machines→Azure SQL Database

The system may automatically provision the same infrastructure in Azure.

The system may identify cheaper alternatives across cloud providers, reduce complexity in cloud transitions by providing seamless migration, provide time efficiency by automating cloud-to-cloud conversion, and provide scalability by supporting multi-cloud strategies with minimal manual intervention.

As a result, the cross-cloud cost comparison and infrastructure migration system can provide cost insights across cloud providers and enable automated cloud infrastructure conversion. The methodology of comparing cost structures and mapping cloud resources while maintaining architectural integrity ensures an innovative approach to cloud optimization and migration.

The system provides cloud cost optimization and multi-cloud infrastructure management. By providing cost comparison and infrastructure conversion capabilities, the system empowers users to make informed decisions about cloud spending and migrations.

As an example, the system may obtain or fetch a cloud computing diagram from a cloud computing platform. In one example, a user may draw the cloud computing diagram.

The system may suggest improvement in the landscape based on cloud best practices using intelligence gathered from other landscapes that are available from the system or other data.

The user may obtain a cost optimization report. The cost optimization report provides cost reduction suggestions and recommendations. As an example, a recommendation may be to move from a first cloud computing platform to a second cloud computing platform.

The system may provide or show an execution plan. The user may select or unselect one or more steps associated with the execution plan.

The system may perform deployment in one of the following ways and present both options to the user:
(A) Terraform/equivalent:
(1) The system may generate a Terraform/equivalent script and execute the script
(2) The user may download the script and manually execute the script
(B) Direct deploying to the new cloud computing platform using a Software Development Kit (SDK) provided by a cloud computing platform/REST API/equivalent

The system may delete cloud resources associated with the first cloud computing platform. As an example, if the user wants to move from a first cloud computing platform to a second cloud computing platform (e.g., AWS to Azure) then an associated AWS network of cloud resources may be deleted.

Aspects of a system and method may include one or more client computing devices that may have a cross-cloud comparison and automated migration application and one or more server computing devices that may have the cross-cloud comparison and automated migration application. A user may use the client computing device to connect to a cloud computing platform account. The user may draw a cloud landscape diagram that represents a cloud computing architecture. Based on the cloud landscape diagram, the cross-cloud comparison and automated migration application may obtain a current monthly cost and compare resource costs of a representation of the cloud computing architecture between multiple different cloud computing platforms. The cross-cloud comparison and automated migration application may display a configuration for each cloud computing platform that is based on the cloud landscape diagram and indicate cost information for each cloud computing platform.

The cross-cloud comparison and automated migration application may determine an equivalent network infrastructure for each cloud computing platform and determine a cost estimation for each cloud computing platform based on the equivalent network infrastructure. The system may present information associated with a cost analysis between the cloud computing platforms. In addition, the cross-cloud comparison and automated migration application may convert one network infrastructure associated with a cloud computing platform to a different cloud computing platform by maintaining architecture, networking, and dependencies during the conversion. In addition, the cross-cloud comparison and automated migration application may perform automated provisioning of target cloud resources in a second cloud computing platform based on a source configuration in the first cloud computing platform. As a result, the system provides infrastructure migration including data transfer as well as secure and compliant data movement between cloud providers. The system may use automated scripts to replicate data storage structures in one cloud computing platform to a second cloud computing platform.

The system includes a computing device comprising a memory storing computer-readable instructions and at least one processor to execute the instructions to receive a cloud computing diagram that represents a cloud computing environment, determine a cloud computing environment in a first cloud computing platform by performing image processing on the cloud computing diagram, determine a cost for the cloud computing environment in the first cloud computing platform and an equivalent cloud computing environment available for at least one second cloud computing platform, display the cost for the cloud computing environment in the first cloud computing platform and the equivalent cloud computing environment available for the at least one second cloud computing platform, receive a selection of the at least one second cloud computing platform and convert the cloud computing environment in the first cloud computing platform to the equivalent cloud computing environment for the at least one second cloud computing platform, and provision cloud resources for the equivalent cloud computing platform for the at least one second cloud computing platform.

In one example, a method includes receiving, by at least one processor, a cloud computing diagram that represents a cloud computing environment, determining, by the at least one processor, a cloud computing environment in a first cloud computing platform by performing image processing on the cloud computing diagram, determining, by the at least one processor, a cost for the cloud computing environment in the first cloud computing platform and an equivalent cloud computing environment available for at least one second cloud computing platform, displaying, by the at least one processor, the cost for the cloud computing environment in the first cloud computing platform and the equivalent cloud computing environment available for the at least one second cloud computing platform, receiving, by the at least one processor, a selection of the at least one second cloud computing platform and converting the cloud computing environment in the first cloud computing platform to the equivalent cloud computing environment for the at least one second cloud computing platform, and provisioning, by the at least one processor, cloud resources for the equivalent cloud computing platform for the at least one second cloud computing platform.

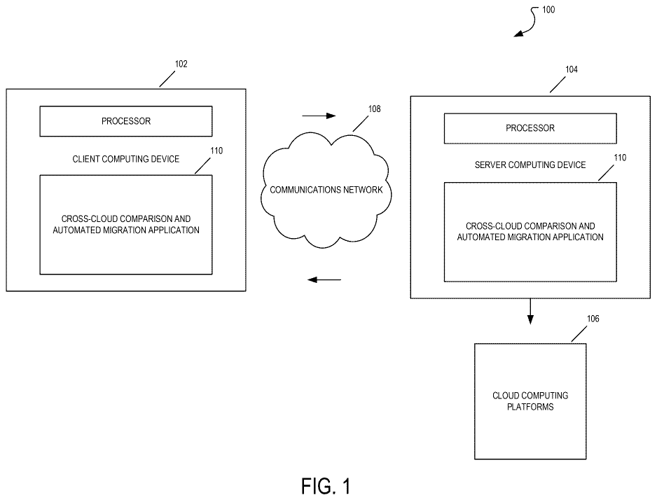

FIG. 1 is a diagram of a cross-cloud comparison and automated migration system 100 according to an example of the instant disclosure. The cross-cloud comparison and automated migration system 100 may include at least one client computing device 102 and at least one server computing device 104 that is in communication via a communication network 108. The at least one client computing device 102 and the at least one server computing device 104 may have an application or at least one component of an application, e.g., a cross-cloud comparison and automated migration application 110. Each of the client computing device 102 and the server computing device 104 may have the application 110 or the at least one component of the application 110. Additionally, the cross-cloud comparison and automated migration system 100 may be associated with compute resources from one or more cloud computing platforms 106. The cloud computing platforms 106 may be one or more of Amazon AWS, IBM Cloud, Google Cloud Platform, Oracle Cloud Infrastructure, Microsoft Azure, and others. In other words, the cloud computing platforms may be Cloud Platform Provider One, Cloud Platform Provider Two, Cloud Platform Three, and others.

The at least one client computing device 102 is configured to receive data from and/or transmit data to the at least one server computing device 104 through the communication network 108. Although the at least one client computing device 102 and the at least one server computing device 104 is shown as a single computing device, it is contemplated that the at least one client computing device 102 and the at least one server computing device 104 may include multiple computing devices.

The communication network 108 can be the Internet, an intranet, or another wired or wireless communication network. For example, the communication network 108 may include a Mobile Communications (GSM) network, a code division multiple access (CDMA) network, 3^{rd} Generation Partnership Project (GPP) network, an Internet Protocol (IP) network, a wireless application protocol (WAP) network, a WiFi network, a Bluetooth network, a Bluetooth Low Energy (BLE) network, a Bluetooth mesh network, a satellite communications network, and an IEEE 802.11 standards network, among others. Other conventional and/or later developed wired and wireless networks may also be used.

The at least one client computing device 102 includes at least one processor to process data and memory to store data. The processor processes communications, builds communications, retrieves data from memory, and stores data to memory. The processor and the memory are hardware. The memory may include volatile and/or non-volatile memory, e.g., a computer-readable storage medium such as a cache, random access memory (RAM), read only memory (ROM), flash memory, or other memory to store data and/or computer-readable executable instructions such as a portion or component of the cross-cloud comparison and automated migration application 110. In addition, the at least one client computing device 102 further includes at least one communications interface to transmit and receive communications, messages, and/or signals.

The server computing device 104 includes at least one processor to process data and memory to store data. The processor processes communications, builds communications, retrieves data from memory, and stores data to memory. The processor and the memory are hardware. The memory may include volatile and/or non-volatile memory, e.g., a computer-readable storage medium such as a cache, random access memory (RAM), read only memory (ROM), flash memory, or other memory to store data and/or computer-readable executable instructions such as a portion or a component of the cross-cloud comparison and automated migration application 110. In addition, the server computing device 104 further includes at least one communications interface to transmit and receive communications, messages, and/or signals.

The at least one client computing device 102 can be a laptop computer, a smartphone, a personal digital assistant, a tablet computer, a standard personal computer, or another processing device. The at least one client computing device 102 may include a display, such as a computer monitor, for displaying data and/or graphical user interfaces. The at least one computing device 102 may also include an input device, such as one or more cameras, a keyboard or a pointing device (e.g., a mouse, trackball, pen, or touch screen) to enter data into or interact with graphical and/or other types of user interfaces. In an example, the display and the input device may be incorporated together as a touch screen of the smartphone or tablet computer.

The at least one client computing device 102 may display on the display a graphical user interface (or GUI). The graphical user interface may be provided by the cross-cloud deployment and automated migration application 110. The graphical user interface enables a user of the at least one client computing device 102 to interact with the cross-cloud deployment and automated migration application 110.

The cross-cloud deployment and automated migration 110 may be a component of an application and/or service executable by the client computing device 102, the server computing device 104, and one or more cloud computing platforms 106 or one or more cloud computing resources that may be from one or more cloud computing providers such as Cloud Computing Platform One, Cloud Computing Platform Two, Cloud Computing Platform Three, and others. For example, the cross-cloud deployment and automated migration application 110 may be a single unit of deployable executable code or a plurality of units of deployable executable code. According to one aspect, the cross-cloud deployment and automated migration application 110 may include one component that may be a web application, a native application, and/or a mobile application (e.g., an app) downloaded from a digital distribution application platform that allows users to browse and download applications developed with mobile software development kits (SDKs) including the APPLE App Store and GOOGLE PLAY®, among others.

The system 100 may also include a relational database management system (RDBMS) or another type of database management system such as a NoSQL database system that stores and communicates data from at least one database. The data stored in the at least one database may be associated with diagrams and cloud computing infrastructure, among other information.

In one example, a user may prepare or draw a diagram and view and edit using the cross-cloud deployment and automated migration application 110. In addition, the user may receive cost information associated with a cloud computing infrastructure that may be associated with each of a number of cloud computing platforms such as a first cloud computing platform, a second cloud computing platform, a third cloud computing platform, etc. The cross-cloud deployment and automated migration application 110 may determine that one cloud computing platform is less expensive than another cloud computing platform and move a cloud computing infrastructure from the first cloud computing platform to a second cloud computing platform.

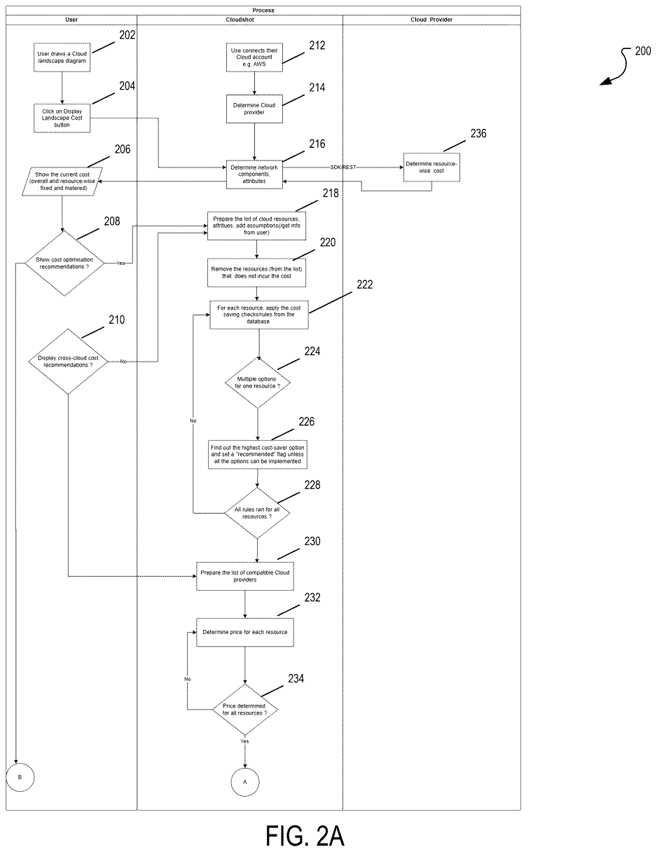

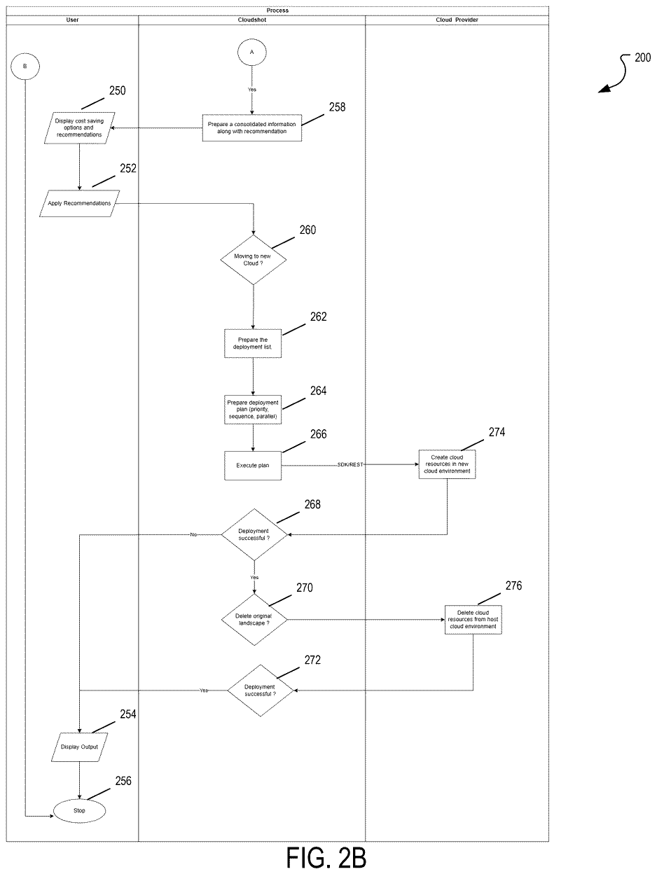

FIG. 2A is an example method 200 of performing cross-cloud comparison and automated migration by the cross-cloud deployment and automated migration system 100 according to an example of the instant disclosure. Although the example method 200 depicts a particular sequence of operations, the sequence may be altered without departing from the scope of the present disclosure. For example, some of the operations depicted may be performed in parallel or in a different sequence that does not materially affect the function of the method 200. In other examples, different components of an example device or system that implements the method 200 may perform functions at substantially the same time or in a specific sequence.

According to some examples, a user may draw a cloud landscape diagram in block 202 and may select or click a display landscape cost user interface element such as a button in block 204. In block 206, the user may view current cost information including overall and resource-wise (fixed and metered). In block 208, the user may be shown cost optimization recommendations. In block 210, the user may be shown cross-cloud cost recommendations. 202, 204, 206, 208, and 210 may be performed by the client computing device 102.

According to some examples, in block 212, a user may connect one or more cloud computing platform accounts to the server computing device 104 by providing user authentication information for each cloud computing platform. Next, in block 214, the server computing device 104 may determine a cloud computing platform provider. In block 216, the server computing device 104 may determine network components and attributes and associated price information. The server computing device 104 may obtain the price information from the cloud computing platforms at a time of the request by the server computing device and/or the price information may be pre-determined and available in the database associated with the server computing device 104. In block 218, the server computing device 104 may prepare a list of cloud resources, attributes, and may add assumptions by obtaining information from the user that is using the client computing device 102. In block 220, resources may be removed from the list. In block 222, for each resource, cost savings may be applied by using saving checks and rules. In block 224, the server computing device 104 may determine whether there are multiple options for one cloud resource and in block 226, a highest cost saving option may be determined and a recommended flag may be set. In block 228, it is determined whether all rules have been run. In block 230, a list of compatible cloud computing platform providers is prepared and in block 232, a price for each cloud computing resource is determined. In block 234, it is determined whether a price is determined for all resources. In block 236, resource information may be obtained from cloud computing platform providers.

FIG. 2B is a continuation of the example method shown in FIG. 2A according to an example of the instant disclosure. As shown in FIG. 2B, in block 258, consolidated information is prepared along with a recommendation by the server computing device 104. In block 250, the client computing device 102 may display cost saving options and recommendations and in block 252, recommendations may be applied by a user of the client computing device 102.

In block 260, the server computing device 104 receives a request to move from a first cloud computing platform to another cloud computing platform. In one example, the user may already have an account with the another cloud computing platform or may have to create a new account with the another cloud computing platform to move a cloud computing environment to the another cloud computing platform. In block 262, the server computing device 104 prepares a deployment list and in block 264 prepares a deployment plan including priority, sequence, and parallel information. In block 266, the server computing device 104 executes the deployment plan and sends information to a cloud computing platform. In block 274, a cloud computing platform creates cloud resources in a new cloud environment. In block 268, the server computing device 104 receives information about the deployment indicating whether the deployment was successful or not successful. In block 270, if the deployment was successful, the server computing device 104 may send a request to delete an original cloud landscape associated with a cloud computing platform. In block 276, a cloud computing platform may delete cloud resources from a host cloud environment. In block 272, the server computing device 104 may receive information from the cloud computing platform that indicates that the delete was successful. In block 254, the client computing device 102 may display information associated with the deployment and in block 256, the method 200 is completed.

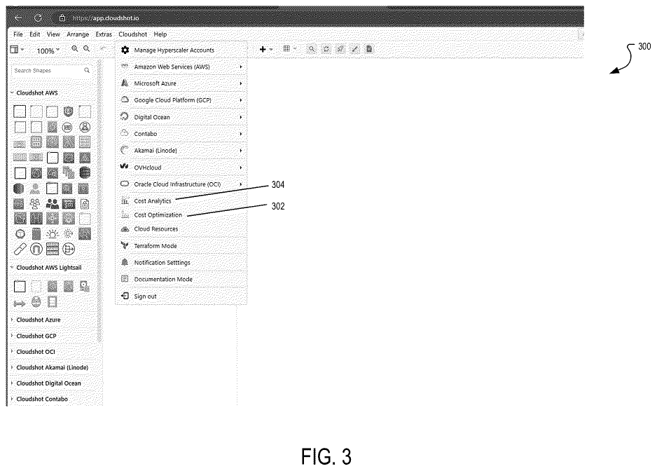

FIG. 3 is a screenshot 300 of a graphical user interface of the cross-cloud deployment and automated migration application 110 according to an example of the instant disclosure. As shown in FIG. 3, there is a dedicated menu bar item for cross-cloud deployment and automated migration. As shown in FIG. 3, the user may start cross-cloud deployment and automated migration using the user interface element associated with Cost Optimization 302 or Cost Analytics 304.

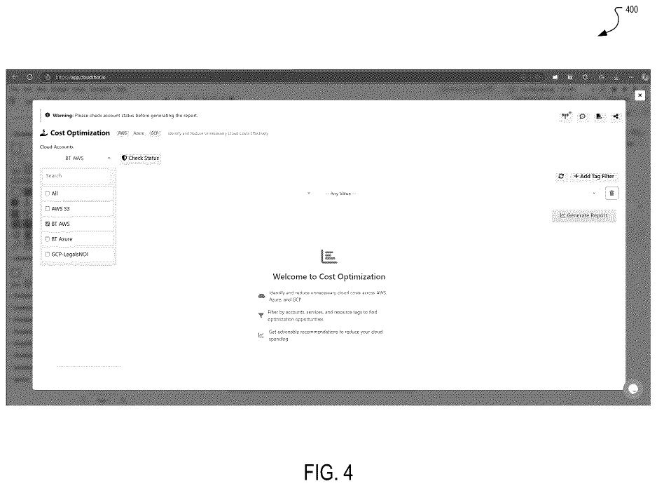

FIG. 4 is a screenshot 400 of the graphical user interface of the cross-cloud deployment and automated migration application 110 according to an example of the instant disclosure. The user interface shown in FIG. 4 is displayed when Cost Optimization 302 has been selected. In one example, FIG. 4 shows how a user can generate a Cost Optimization Report (COR). The COR provides information associated with one or more accounts that the user has connected with the server computing device 104. The COR may be used to identify and reduce costs across multiple cloud computing platforms. A user may filter by accounts, services, and resource tags to find optimization opportunities. In addition, the COR provides actionable recommendations to reduce cloud spending.

A user can select one or more accounts and the server computing device 104 may implement a cost implementation rule set. As shown in FIG. 4, there are options that a user can select including All, AWS S3, BT AWS, BT Azure, and GCP-LegalsNOI. FIG. 4 also shows certain filter criteria, e.g., based on tags. In one example, a user can choose to run the COR for a select set of resources, e.g., Environment=Production and/or Cost-center=Engineering, etc. In this example, the user has selected an AWS account only.

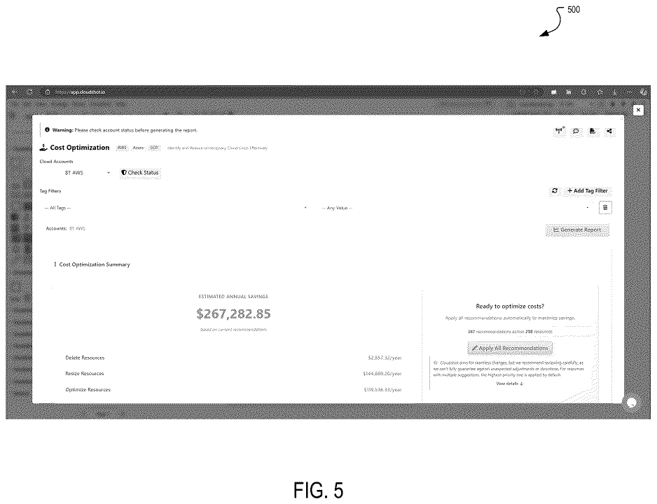

FIG. 5 is a screenshot 500 of the graphical user interface of the cross-cloud deployment and automated migration application 110 according to an example of the instant disclosure. FIG. 5 shows an output of COR. As an example, there is an estimated savings of $267,282.83 per year. The break-up is shown in terms of how many resources can be deleted (because they are not in use), how many resources can be right-sized (e.g., converging 16 GB RAM machine to 8 GB RAM etc.) and how many resources can be optimized e.g., setting a RAM of a lambda function from 128 MB to 256 MB.

As shown in FIG. 5, there is a user interface element, e.g., a button, labeled “Apply All Recommendations.” When this button is selected, the server computing device 104 implements cost saving suggestions for the user that in this example includes 387 recommendations across 298 resources. As shown in FIG. 5, there are savings associated with deleting resources of $2,857.32 per year, savings associated with resizing resources of $144,889.20 per year, and savings associated with optimizing resources of $119,536.33 per year. After implementing the cost saving suggestions, results are displayed.

As an example, the comparative price of an AWS network is shown in other cloud providers such as Azure, GCP, Digital Ocean, etc. A user may select a user interface element such as a button to move the cloud computing infrastructure from a first cloud computing platform to a second cloud computing platform. After selecting the user interface element, the server computing device 104 may create the cloud computing infrastructure and migrate data from cloud components including virtual machines and databases etc.

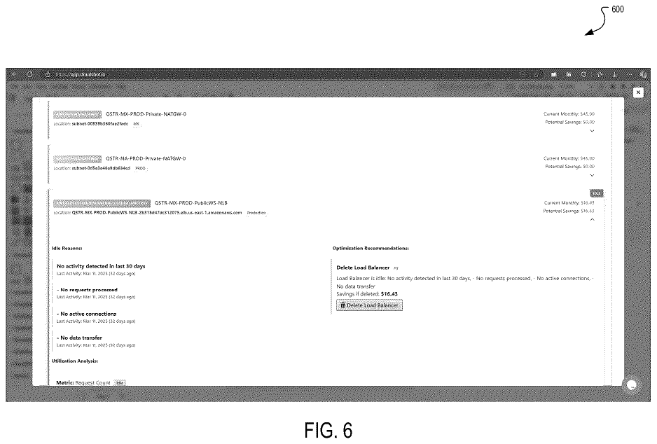

FIG. 6 is a screenshot 600 of the graphical user interface of the cross-cloud deployment and automated migration application 110 according to an example of the instant disclosure. As shown in FIG. 6, individual recommendations are listed. For example, this screenshot 600 shows that a NLB (Network Load Balancer) is not in use for a last thirty days and hence can be deleted. The associated savings would be $16.43 per month. A user may select a user interface element such as the button “Delete Load Balancer” to delete the load balancer.

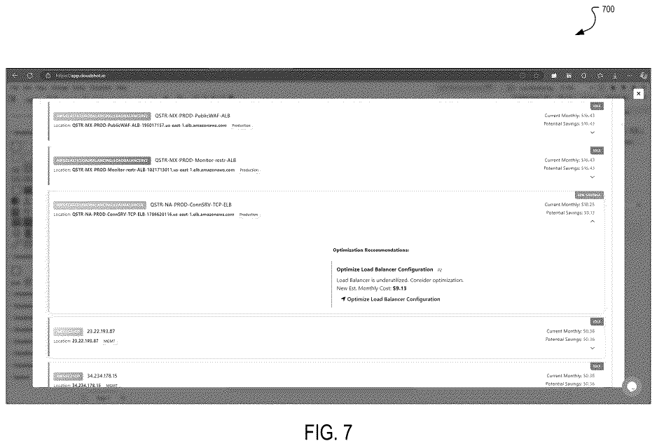

FIG. 7 is a screenshot 700 of the graphical user interface of the cross-cloud deployment and automated migration application 110 according to an example of the instant disclosure. Some resources may not be deleted but can be optimized. The ELB (Elastic Load Balancer) is under-utilized in this example. Refinement may provide the user with 50% savings. The user may select a user interface element such as the button “Optimize Load Balance Configuration” to optimize the load balancer configuration.

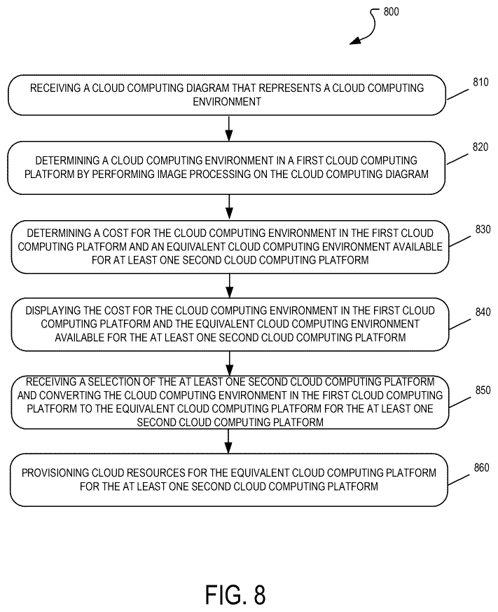

FIG. 8 shows a flowchart of a method 800 of cross-cloud deployment and automated migration according to an example of the instant disclosure. Although the example method 800 depicts a particular sequence of operations, the sequence may be altered without departing from the scope of the present disclosure. For example, some of the operations depicted may be performed in parallel or in a different sequence that does not materially affect the function of the method 800. In other examples, different components of an example device or system that implements the method 800 may perform functions at substantially the same time or in a specific sequence.

According to some examples, the method 800 may include receiving, by at least one processor, a cloud computing diagram that represents a cloud computing environment at block 810.

According to some examples, the method 800 may include determining, by the at least one processor, a cloud computing environment in a first cloud computing platform by performing image processing on the cloud computing diagram at block 820.

According to some examples, the method 800 may include determining, by the at least one processor, a cost for the cloud computing environment in the first cloud computing platform and an equivalent cloud computing environment available for at least one second cloud computing platform at block 830.

According to some examples, the method 800 may include displaying, by the at least one processor, the cost for the cloud computing environment in the first cloud computing platform and the equivalent cloud computing environment available for the at least one second cloud computing platform at block 840.

According to some examples, the method 800 may include receiving, by the at least one processor, a selection of the at least one second cloud computing platform and converting the cloud computing environment in the first cloud computing platform to the equivalent cloud computing environment for the at least one second cloud computing platform at block 850.

According to some examples, the method 800 may include provisioning, by the at least one processor, cloud resources for the equivalent cloud computing platform for the at least one second cloud computing platform at block 860.

According to some examples, the method 800 may include maintaining architecture, networking, and dependencies of the cloud computing environment while at least partially converting the cloud computing environment in the first cloud computing platform to the equivalent or a non-equivalent cloud computing environment for the at least one second cloud computing platform.

According to some examples, the method 800 may include determining pricing information such as realtime pricing information for the cloud computing environment in the first cloud computing platform and the equivalent cloud computing environment available for the at least one second cloud computing platform.

According to some examples, the method 800 may include transmitting a request such as a web application programming interface (API) request to the first cloud computing platform and each of the at least one second cloud computing platform to obtain the pricing information for the cloud computing environment in the first cloud computing platform and the equivalent cloud computing environment available for the at least one second cloud computing platform.

According to some examples, the method 800 may include using a script or a Terraform-based template or Ansible-based template to convert the cloud computing environment in the first cloud computing platform to the equivalent cloud computing platform for the at least one second cloud computing platform.

According to some examples, the method 800 may include determining an estimated savings for a period of time such as per month or per year for the equivalent cloud computing platform for the at least one second cloud computing platform as compared with the cloud computing environment in the first cloud computing platform.

According to some examples, the method 800 may include determining a number of cloud resources that can be deleted, a number of cloud resources that can be right-sized, and a number of cloud resources that can be optimized for the equivalent cloud computing platform for the at least one second cloud computing platform as compared with the cloud computing environment in the first cloud computing platform.

According to some examples, the method 800 may include receiving a request to delete at least one cloud resource associated with the first cloud computing platform and deleting the at least one cloud resource.

According to some examples, the method 800 may include receiving a request to optimize at least one cloud resource associated with the first cloud computing platform and optimizing the at least one cloud resource.

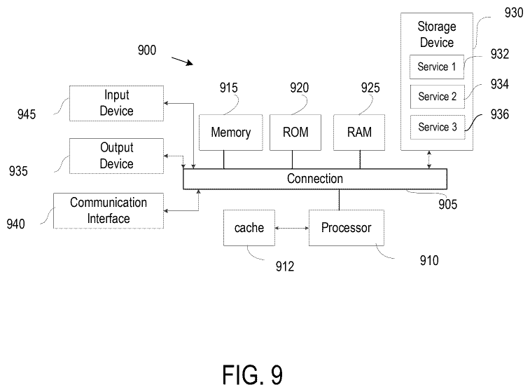

FIG. 9 shows an example of computing system 900, which can be for example the client computing device 102, the server computing device 104, compute resources associated with one of the cloud computing platforms 106, or any component thereof in which the components of the system are in communication with each other using connection 905. Connection 905 can be a physical connection via a bus, or a direct connection into processor 910, such as in a chipset architecture. Connection 905 can also be a virtual connection, networked connection, or logical connection.

In some embodiments, computing system 900 is a distributed system in which the functions described in this disclosure can be distributed within a datacenter, multiple data centers, a peer network, etc. In some embodiments, one or more of the described system components represents many such components each performing some or all of the function for which the component is described. In some embodiments, the components can be physical or virtual devices.

Example system 900 includes at least one processing unit (CPU or processor) 910 and connection 905 that couples various system components including system memory 915, such as read-only memory (ROM) 920 and random access memory (RAM) 925 to processor 910. Computing system 900 can include a cache of high-speed memory 912 connected directly with, in close proximity to, or integrated as part of processor 910.

Processor 910 can include any general purpose processor and a hardware service or software service, such as services 932, 934, and 936 stored in storage device 930, configured to control processor 910 as well as a special-purpose processor where software instructions are incorporated into the actual processor design. Processor 910 may essentially be a completely self-contained computing system, containing multiple cores or processors, a bus, memory controller, cache, etc. A multi-core processor may be symmetric or asymmetric.

To enable user interaction, computing system 900 includes an input device 945, which can represent any number of input mechanisms, such as a microphone for speech, a touch-sensitive screen for gesture or graphical input, keyboard, mouse, motion input, speech, etc. Computing system 900 can also include output device 935, which can be one or more of a number of output mechanisms known to those of skill in the art. In some instances, multimodal systems can enable a user to provide multiple types of input/output to communicate with computing system 900. Computing system 900 can include communications interface 940, which can generally govern and manage the user input and system output. There is no restriction on operating on any particular hardware arrangement, and therefore the basic features here may easily be substituted for improved hardware or firmware arrangements as they are developed.

Storage device 930 can be a non-volatile memory device and can be a hard disk or other types of computer readable media which can store data that are accessible by a computer, such as magnetic cassettes, flash memory cards, solid state memory devices, digital versatile disks, cartridges, random access memories (RAMs), read-only memory (ROM), and/or some combination of these devices.

The storage device 930 can include software services, servers, services, etc., that when the code that defines such software is executed by the processor 910, it causes the system to perform a function. In some embodiments, a hardware service that performs a particular function can include the software component stored in a computer-readable medium in connection with the necessary hardware components, such as processor 910, connection 905, output device 935, etc., to carry out the function.

For clarity of explanation, in some instances, the present technology may be presented as including individual functional blocks including functional blocks comprising devices, device components, steps or routines in a method embodied in software, or combinations of hardware and software.

Any of the steps, operations, functions, or processes described herein may be performed or implemented by a combination of hardware and software services or services, alone or in combination with other devices. In some embodiments, a service can be software that resides in memory of a client device and/or one or more servers of a content management system and perform one or more functions when a processor executes the software associated with the service. In some embodiments, a service is a program or a collection of programs that carry out a specific function. In some embodiments, a service can be considered a server. The memory can be a non-transitory computer-readable medium.

In some embodiments, the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer-readable media. Such instructions can comprise, for example, instructions and data which cause or otherwise configure a general purpose computer, special purpose computer, or special purpose processing device to perform a certain function or group of functions. Portions of computer resources used can be accessible over a network. The executable computer instructions may be, for example, binaries, intermediate format instructions such as assembly language, firmware, or source code. Examples of computer-readable media that may be used to store instructions, information used, and/or information created during methods according to described examples include magnetic or optical disks, solid-state memory devices, flash memory, USB devices provided with non-volatile memory, networked storage devices, and so on.

Devices implementing methods according to these disclosures can comprise hardware, firmware and/or software, and can take any of a variety of form factors. Typical examples of such form factors include servers, laptops, smartphones, small form factor personal computers, personal digital assistants, and so on. The functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Illustrative examples of the disclosure include:
Aspect 1: A method comprising receiving, by at least one processor, a cloud computing diagram that represents a cloud computing environment, determining, by the at least one processor, a cloud computing environment in a first cloud computing platform by performing image processing on the cloud computing diagram, determining, by the at least one processor, a cost for the cloud computing environment in the first cloud computing platform and an equivalent cloud computing environment available for at least one second cloud computing platform, displaying, by the at least one processor, the cost for the cloud computing environment in the first cloud computing platform and the equivalent cloud computing environment available for the at least one second cloud computing platform, receiving, by the at least one processor, a selection of the at least one second cloud computing platform and converting the cloud computing environment in the first cloud computing platform to the equivalent cloud computing environment for the at least one second cloud computing platform, and provisioning, by the at least one processor, cloud resources for the equivalent cloud computing platform for the at least one second cloud computing platform.
Aspect 2: The method of Aspect 1, further comprising maintaining architecture, networking, and dependencies of the cloud computing environment while at least partially converting the cloud computing environment in the first cloud computing platform to the equivalent or a non-equivalent cloud computing environment for the at least one second cloud computing platform.
Aspect 3: The method of Aspects 1 and 2, further comprising determining pricing information for the cloud computing environment in the first cloud computing platform and the equivalent cloud computing environment available for the at least one second cloud computing platform.
Aspect 4: The method of Aspects 1 to 3, further comprising transmitting a request to the first cloud computing platform and each of the at least one second cloud computing platform to obtain the pricing information for the cloud computing environment in the first cloud computing platform and the equivalent cloud computing environment available for the at least one second cloud computing platform.
Aspect 5: The method of Aspects 1 to 4, further comprising using script to convert the cloud computing environment in the first cloud computing platform to the equivalent cloud computing platform for the at least one second cloud computing platform.
Aspect 6: The method of Aspects 1 to 5, further comprising determining an estimated savings for a period of time for the equivalent cloud computing platform for the at least one second cloud computing platform as compared with the cloud computing environment in the first cloud computing platform.
Aspect 7: The method of Aspects 1 to 6, further comprising determining a number of cloud resources that can be deleted, a number of cloud resources that can be right-sized, and a number of cloud resources that can be optimized for the equivalent cloud computing platform for the at least one second cloud computing platform as compared with the cloud computing environment in the first cloud computing platform.
Aspect 8: The method of Aspects 1 to 7, further comprising receiving a request to delete at least one cloud resource associated with the first cloud computing platform and deleting the at least one cloud resource.
Aspect 9: The method of Aspects 1 to 8, further comprising receiving a request to optimize at least one cloud resource associated with the first cloud computing platform and optimizing the at least one cloud resource.
Aspect 10: A system comprising a computing device comprising a memory storing computer-readable instructions and at least one processor to execute the instructions to receive a cloud computing diagram that represents a cloud computing environment, determine a cloud computing environment in a first cloud computing platform by performing image processing on the cloud computing diagram, determine a cost for the cloud computing environment in the first cloud computing platform and an equivalent cloud computing environment available for at least one second cloud computing platform, display the cost for the cloud computing environment in the first cloud computing platform and the equivalent cloud computing environment available for the at least one second cloud computing platform, receive a selection of the at least one second cloud computing platform and convert the cloud computing environment in the first cloud computing platform to the equivalent cloud computing environment for the at least one second cloud computing platform, and provision cloud resources for the equivalent cloud computing platform for the at least one second cloud computing platform.
Aspect 11: The system of Aspect 10, the at least one processor further to execute the instructions to maintain architecture, networking, and dependencies of the cloud computing environment while at least partially converting the cloud computing environment in the first cloud computing platform to the equivalent or a non-equivalent cloud computing environment for the at least one second cloud computing platform.
Aspect 12: The system of Aspects 10 and 11, the at least one processor further to execute the instructions to determine pricing information for the cloud computing environment in the first cloud computing platform and the equivalent cloud computing environment available for the at least one second cloud computing platform.
Aspect 13: The system of Aspects 10 to 12, the at least one processor further to execute the instructions to transmit a request to the first cloud computing platform and each of the at least one second cloud computing platform to obtain the realtime pricing for the cloud computing environment in the first cloud computing platform and the equivalent cloud computing environment available for the at least one second cloud computing platform.
Aspect 14: The system of Aspects 10 to 13, the at least one processor further to execute the instructions to use a script to convert the cloud computing environment in the first cloud computing platform to the equivalent cloud computing platform for the at least one second cloud computing platform.
Aspect 15: The system of Aspects 10 to 14, the at least one processor further to execute the instructions to determine an estimated savings for a period of time for the equivalent cloud computing platform for the at least one second cloud computing platform as compared with the cloud computing environment in the first cloud computing platform.
Aspect 16: The system of Aspects 10 to 15, the at least one processor further to execute the instructions to determine a number of cloud resources that can be deleted, a number of cloud resources that can be right-sized, and a number of cloud resources that can be optimized for the equivalent cloud computing platform for the at least one second cloud computing platform as compared with the cloud computing environment in the first cloud computing platform.
Aspect 17: The system of Aspects 10 to 16, the at least one processor further to execute the instructions to receive a request to delete at least one cloud resource associated with the first cloud computing platform and delete the at least one cloud resource.
Aspect 18: The system of Aspects 10 to 17, the at least one processor further to execute the instructions to receive a request to optimize at least one cloud resource associated with the first cloud computing platform and optimize the at least one cloud resource.
Aspect 19: A non-transitory computer-readable storage medium comprising instructions stored thereon that, when executed by a computing device cause the computing device to perform operations, the operations comprising receiving a cloud computing diagram that represents a cloud computing environment, determining a cloud computing environment in a first cloud computing platform by performing image processing on the cloud computing diagram, determining a cost for the cloud computing environment in the first cloud computing platform and an equivalent cloud computing environment available for at least one second cloud computing platform, displaying the cost for the cloud computing environment in the first cloud computing platform and the equivalent cloud computing environment available for the at least one second cloud computing platform, receiving a selection of the at least one second cloud computing platform and converting the cloud computing environment in the first cloud computing platform to the equivalent cloud computing environment for the at least one second cloud computing platform, and provisioning cloud resources for the equivalent cloud computing platform for the at least one second cloud computing platform.
Aspect 20: The non-transitory computer-readable storage medium of Aspect 19, the operations further comprising maintaining architecture, networking, and dependencies of the cloud computing environment while at least partially converting the cloud computing environment in the first cloud computing platform to the equivalent or a non-equivalent cloud computing environment for the at least one second cloud computing platform.

It is believed that the present disclosure and many of its attendant advantages will be understood by the foregoing description, and it will be apparent that various changes may be made in the form, construction and arrangement of the components without departing from the disclosed subject matter or without sacrificing all of its material advantages. The form described is merely explanatory, and it is the intention of the following claims to encompass and include such changes.

While the present disclosure has been described with reference to various embodiments, it will be understood that these embodiments are illustrative and that the scope of the disclosure is not limited to them. Many variations, modifications, additions, and improvements are possible. More generally, embodiments in accordance with the present disclosure have been described in the context of particular implementations. Functionality may be separated or combined in blocks differently in various embodiments of the disclosure or described with different terminology. These and other variations, modifications, additions, and improvements may fall within the scope of the disclosure as defined in the claims that follow.

What is claimed is:

1. A method comprising:
receiving, by at least one processor, a cloud computing diagram that represents a cloud computing environment;
determining, by the at least one processor, a cloud computing environment in a first cloud computing platform by performing image processing on the cloud computing diagram;
determining, by the at least one processor, a cost for the cloud computing environment in the first cloud computing platform and an equivalent cloud computing environment available for at least one second cloud computing platform;
displaying, by the at least one processor, the cost for the cloud computing environment in the first cloud computing platform and the equivalent cloud computing environment available for the at least one second cloud computing platform;
receiving, by the at least one processor, a selection of the at least one second cloud computing platform and converting the cloud computing environment in the first cloud computing platform to the equivalent cloud computing environment for the at least one second cloud computing platform; and
provisioning, by the at least one processor, cloud resources for the equivalent cloud computing platform for the at least one second cloud computing platform.

2. The method of claim 1, further comprising:
maintaining architecture, networking, and dependencies of the cloud computing environment while at least partially converting the cloud computing environment in the first cloud computing platform to the equivalent or a non-equivalent cloud computing environment for the at least one second cloud computing platform.

3. The method of claim 1, further comprising determining pricing information for the cloud computing environment in the first cloud computing platform and the equivalent cloud computing environment available for the at least one second cloud computing platform.

4. The method of claim 3, further comprising transmitting a request to the first cloud computing platform and each of the at least one second cloud computing platform to obtain the pricing information for the cloud computing environment in the first cloud computing platform and the equivalent cloud computing environment available for the at least one second cloud computing platform.

5. The method of claim 1, further comprising using a script to convert the cloud computing environment in the first cloud computing platform to the equivalent cloud computing platform for the at least one second cloud computing platform.

6. The method of claim 1, further comprising determining an estimated savings for a period of time for the equivalent cloud computing platform for the at least one second cloud computing platform as compared with the cloud computing environment in the first cloud computing platform.

7. The method of claim 1, further comprising determining a number of cloud resources that can be deleted, a number of cloud resources that can be right-sized, and a number of cloud resources that can be optimized for the equivalent cloud computing platform for the at least one second cloud computing platform as compared with the cloud computing environment in the first cloud computing platform.

8. The method of claim 1, further comprising receiving a request to delete at least one cloud resource associated with the first cloud computing platform and deleting the at least one cloud resource.

9. The method of claim 1, further comprising receiving a request to optimize at least one cloud resource associated with the first cloud computing platform and optimizing the at least one cloud resource.

10. A system comprising:
a computing device comprising a memory storing computer-readable instructions; and
at least one processor to execute the instructions to:
receive a cloud computing diagram that represents a cloud computing environment;
determine a cloud computing environment in a first cloud computing platform by performing image processing on the cloud computing diagram;
determine a cost for the cloud computing environment in the first cloud computing platform and an equivalent cloud computing environment available for at least one second cloud computing platform;
display the cost for the cloud computing environment in the first cloud computing platform and the equivalent cloud computing environment available for the at least one second cloud computing platform;
receive a selection of the at least one second cloud computing platform and convert the cloud computing environment in the first cloud computing platform to the equivalent cloud computing environment for the at least one second cloud computing platform; and
provision cloud resources for the equivalent cloud computing platform for the at least one second cloud computing platform.

11. The system of claim 10, the at least one processor further to execute the instructions to maintain architecture, networking, and dependencies of the cloud computing environment while at least partially converting the cloud computing environment in the first cloud computing platform to the equivalent or a non-equivalent cloud computing environment for the at least one second cloud computing platform.

12. The system of claim 10, the at least one processor further to execute the instructions to determine pricing information for the cloud computing environment in the first cloud computing platform and the equivalent cloud computing environment available for the at least one second cloud computing platform.

13. The system of claim 12, the at least one processor further to execute the instructions to transmit a request to the first cloud computing platform and each of the at least one second cloud computing platform to obtain the pricing information for the cloud computing environment in the first cloud computing platform and the equivalent cloud computing environment available for the at least one second cloud computing platform.

14. The system of claim 10, the at least one processor further to execute the instructions to use a script to convert the cloud computing environment in the first cloud computing platform to the equivalent cloud computing platform for the at least one second cloud computing platform.

15. The system of claim 10, the at least one processor further to execute the instructions to determine an estimated savings for a period of time for the equivalent cloud computing platform for the at least one second cloud computing platform as compared with the cloud computing environment in the first cloud computing platform.

16. The system of claim 10, the at least one processor further to execute the instructions to determine a number of cloud resources that can be deleted, a number of cloud resources that can be right-sized, and a number of cloud resources that can be optimized for the equivalent cloud computing platform for the at least one second cloud computing platform as compared with the cloud computing environment in the first cloud computing platform.

17. The system of claim 10, the at least one processor further to execute the instructions to receive a request to delete at least one cloud resource associated with the first cloud computing platform and delete the at least one cloud resource.

18. The system of claim 10, the at least one processor further to execute the instructions to receive a request to optimize at least one cloud resource associated with the first cloud computing platform and optimize the at least one cloud resource.

19. A non-transitory computer-readable storage medium comprising instructions stored thereon that, when executed by a computing device cause the computing device to perform operations, the operations comprising:
receiving a cloud computing diagram that represents a cloud computing environment;
determining a cloud computing environment in a first cloud computing platform by performing image processing on the cloud computing diagram;
determining a cost for the cloud computing environment in the first cloud computing platform and an equivalent cloud computing environment available for at least one second cloud computing platform;
displaying the cost for the cloud computing environment in the first cloud computing platform and the equivalent cloud computing environment available for the at least one second cloud computing platform;
receiving a selection of the at least one second cloud computing platform and converting the cloud computing environment in the first cloud computing platform to the equivalent cloud computing environment for the at least one second cloud computing platform; and
provisioning cloud resources for the equivalent cloud computing platform for the at least one second cloud computing platform.

20. The non-transitory computer-readable medium of claim 19, the operations further comprising:
maintaining architecture, networking, and dependencies of the cloud computing environment while at least partially converting the cloud computing environment in the first cloud computing platform to the equivalent or a non-equivalent cloud computing environment for the at least one second cloud computing platform.
